(19) United States
(12) Patent Application Publication
(10) Pub. No.: US 2003/0057270 A1
(43) Pub. Date: Mar. 27, 2003

(54) Location identification system and method

(76) Inventor: Jess M. Collen, Briarcliff Manor, NY (US)

Correspondence Address: Jess M. Collen, The Holyoke-Manhattan Building, 80 South Highland Avenue, Ossining, NY, 10562, US

(21) Appl. No.: 10/237,925

(22) Filed: Sep. 9, 2002

Related U.S. Application Data
(60) Provisional application No. 60/322,658, filed on Sep. 17, 2001.

(51) Int. Cl. G06F 17/00

(52) U.S. Cl. 235/375

(57) ABSTRACT

This invention relates to identification systems. An identifier is located at a specific point on some structure which a reading device registers the specific address when placed in proximity to the physical location, hence simplifying and adding certainty to address location, for purposes of commercial use in the nature of delivery or service calls, personal use, as in identifying locations of houses or structures in unfamiliar locations, or for emergency use, such as by police or firefighters.

This invention claims the benefit of U.S. Provisional Application No. 60/322,658, filed Sep. 17, 2001.

### BACKGROUND OF THE INVENTION

1. Field of Invention

The present invention relates generally to identification systems. More specifically, the invention relates to a method for a system and method identifying street locations for buildings, structures, geographic landmarks, and locations by utilizing identification means and a detecting device which can read or recognize the specific locations.

2. Description of the Related Art

Identifying street addresses is an age-old problem. Although any variety of means have been tried to urge homeowners, businesses, and property owners to clearly mark and identify, a variety of issues including poor lighting, overgrowth of vegetation, missing markings, vandalism, and simple non-participation all contribute to an absence of a reliable, functional method for identifying. Many devices have been directed to the concept of providing devices to illuminate house identifying information, some even to facilitate automatic house address illuminating displays. Despite this prior art, there is no means for reliably and instantly identifying houses, buildings, structure, and property. Note that this issue and problem is not restricted simply to constructed buildings but is particularly acute with regard to raw land which may need to be identified for a variety of reasons ranging from offering for sale, locating utilities or other easements which are identified by property site, tax assessment, or public safety issues.

### SUMMARY OF THE INVENTION

The present invention is generally directed to satisfying the need to quickly and accurately identify property by street address or other identifying means. The problem of an accurate method for use by businesses, organizations and individuals, ranging from public safety to delivery, to convenience are all solved by the present invention.

In accordance with one preferred embodiment of the present invention, this need can be satisfied by placing bar codes on each piece of property. The bar code is mounted as a stand-alone device, on a stake, or can be mounted to existing structures, either at curbside or on a structure itself. For example, the bar code could be affixed to the mailbox.

The bar code registers the street number or block number, when read by a bar code reading device.

Such devices can also be mounted in an automobile dashboard or be an accessory. Existing bar code reading technology is utilized for the purpose of scanning or reading the information from the bar codes. A display on the bar code reading device indicates the number.

In this way, particularly at night when trying to find a particular house or street number, due to the problem of obstructed numbers or even irregularly numbered streets, the device immediately allows any user to identify the address of any place which is sought.

In an alternative embodiment, any other identification means such as a transmitter, which broadcasts information can be used, employing, for instance, radio frequency or existing radio or cellular technology so that the reading device for an individual can be a personal digital assistant or other hand-held computer operated wireless telephone or other computer type or microprocessor of device.

Yet another alternative embodiment of the reading device permits delivery companies such as the postal service, private courier and overnight express companies, package delivery services, utilities, or other service people to readily and instantly identify every address which is sought. In another embodiment of the reader, it is permanently mounted on a delivery or service vehicle of any sort, and uses a display which will register each house or lot number as that house or lot is passed or approached by the delivery or service vehicle. This can even be used, therefore, by small delivery services and companies of a local nature such as dry cleaners, or food delivery persons such as for take-out restaurants.

In yet another embodiment, this system can also be used by municipalities on road signs or public structures, giving people seeking street and street locations instant identification. The system can be further refined so that the street location signs provide not only the street name but the “block number”, listing all of the addresses to be found between one street and the next cross street A further embodiment provides for identification means indicating street or location identification numbers on either side or all sides of any given intersection.

Further, the information from any receiver or transmitter device is interfaced with a database which provides further address verification information for individual locations such as linking a company name to a given address, in the form of a directory, such that if, for instance, a delivery vehicle were to pass an address as 145 Main Street, when the bar code or transmitting device encoded, emitted or broadcast the signal for identifying a specific location, the signal is transmitted via modem or other data exchange, or other data communication technology, to a computer data base which displays on the screen the name of the residence, business, institution, and so forth, for that specific address.

In yet another embodiment, the bar code information interfaces with satellite-based or other global positioning systems (GPS). Such systems, which typically can take a user to a specific street or location, can further rely on the individual bar codes to identify a specific site within a location, identified with even more precision than that provided by the GPS. Existing GPS hand-held devices may be adapted to read the signals or transmissions from the remote bar codes or transponders.

The transponder or signal emitting devices themselves may be connected to a wired or wireless network, and activated when an inquiry is made by a reading device.

In open undeveloped, unimproved land, whether public space or private property, locators can be put in unobtrusive locations. Even areas surrounding landmarks at historic or tourist or entertainment sites can be utilized to identify the specific name of the location.

Amusement parks may utilize the system to identify specific rides or attractions, for instance, within their confines. Shopping malls can broadcast information to passing customers about merchandise, specials or other information.

### BRIEF DESCRIPTION OF THE DRAWINGS

The invention is explained in further detail, and by way of example, with reference to the accompanying drawings wherein:

FIG. 1 illustrates an example diagram of a location determination system in accordance with this invention.

FIG. 2 illustrates an example block diagram of a bar-code embodiment of a location determination system in accordance with this invention.

FIG. 3 illustrates an example block diagram of an RFID embodiment of a location determination system in accordance with this invention.

FIG. 4 illustrates an example block diagram of components of an RFID embodiment of a location determination system in accordance with this invention.

Throughout the drawings, the same reference numerals indicate similar or corresponding features or functions.

### DETAILED DESCRIPTION OF THE INVENTION

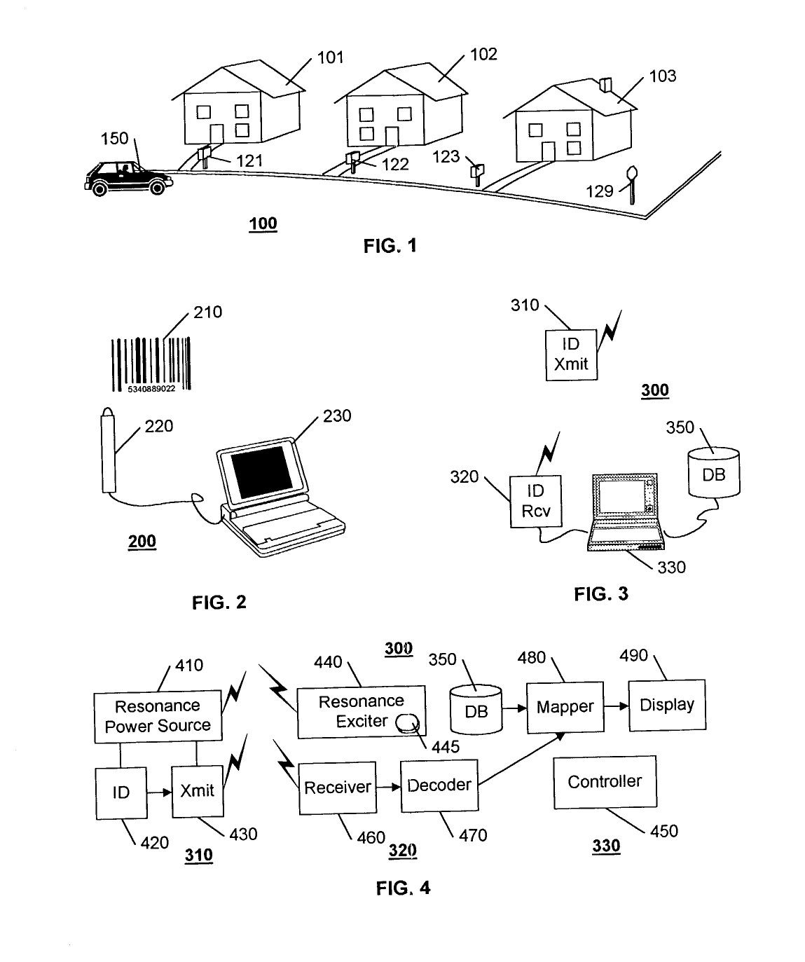

FIG. 1 illustrates an example diagram of a location determination system 100 in accordance with this invention. The system 100 includes a plurality of location identifiers 121-129 that are configured to provide an identification of locales 101-103. In accordance with this invention, a mobile location detector 150 is configured to receive the identification of the locales 101-103 from the location identifiers 121-129, and to render a location message corresponding to the identifications provided by the location identifiers 121-129.

In a preferred embodiment of this invention, the identifiers 121-129 are remotely accessible by the location detector 150. In a straightforward embodiment, the identifiers 121-129 are bar-code stickers that are attached to structures that are associated with the locales 101-103, and the detector 150 is a bar-code reader that reads the content of each sticker via a visual scanning of the sticker. In a more advanced embodiment, the identifiers 121-129 are RFID (Radio Frequency IDentifier) transmitters that communicate an identifier via a radio-frequency transmission. Other means of communicating an identifier from the identifiers 121-129 to a detector 150 will be evident to one of ordinary skill in the art in view of this disclosure.

The identifiers 121-129 may identify a single locale 101, 102, 103, or a plurality of locales 101-103. For example, individual identifiers 121-123 may be located at each locale 101-103, and/or a group identifier 129 may be located at a site that is associated with a plurality of locales, such as a street-corner.

The identifiers 121-129 may provide unique identifications for each locale, or identifications that are part of a hierarchical identification system. That is, for example, the identifications may be unique within a given geographic region, and an identification of the geographic region may need to be provided to the detector 150. This region identification may be explicit, implicit, or automated. For example, the user may explicitly select a region from a menu to initialize the detector 150, or the user may download a database that corresponds to the particular region, thereby implicitly configuring the detector 150 for this region. In an automated system, the detector 150 may contain, or be coupled to, a location-determination device, such as a GPS receiver that serves to identify the current geographic region of the detector 150.

FIG. 2 illustrates an example block diagram of a bar-code embodiment 200 of a location determination system in accordance with this invention. In this embodiment 200, a bar-code 210 is affixed to a structure that is accessible/scan-able by a remote scanning device 220. The scanning device 220 provides the scanned identifier to a processing device 230, such as a laptop or palm-top computer system. The encoding of the bar-code 210 may merely correspond to the numeric address of the locale, on the assumption that the user of the system 230 will know the street name to which the number applies, or it may be an index to a database that includes a more complete identification of the locale, as discussed further below.

FIG. 3 illustrates an example block diagram of an RFID embodiment 300 of a location determination system in accordance with this invention. In this embodiment, a Radio-Frequency IDentifier (RFID) transmitter 310 is affixed to a structure that is associated with each locale 101, 102, 103 of FIG. 1 or a plurality of locales 101-103. U.S. Pat. No. 6,265,977, “RADIO FREQUENCY IDENTIFICATION TAG APPARATUS AND RELATED METHOD”, issued 24 Jul. 2001 to Victor Allen Vega and Noel H. Eberhardt, details the design of a typical RFID device, and is incorporated by reference herein. The location detector 150 of FIG. 1 in this embodiment includes an RFID receiver 320 and a processing device 330, such as a laptop or palmtop computer, or merely a device that displays the information provided by the RFID receiver 320. Optionally, the detector 150 includes a database 350 that facilitates an identification of the locale or locales based on the information received by the RFID receiver 320.

FIG. 4 illustrates an example block diagram of components of an RFID embodiment of a location determination system 300 in accordance with this invention. In this example embodiment, the system 300 includes an RFID transmitter 310 that comprises a resonance power source 410, an ID memory 420, and a transmitter 430. The resonance power source 410 is configured to provide power to the transmitter 430 upon receipt of an excitation signal at the resonant frequency of the source 410. A resonance exciter 440 in an RFID receiver 320 is configured to provide this excitation signal at the resonant frequency when activated, via for example, a push-button 445. That is, a user of the RFID receiver 320 activates the exciter 440 when seeking a location identifier. If there is an RFID transmitter 310 in the vicinity of the receiver 320, the resonance power source 410 of this transmitter 310 receives the excitation signal, and provides power to the transmitter 430 to transmit the ID 420 of the transmitter 310. Alternatively, the transmitter 310 may be connected to a continuous power source, and will be configured to continuously transmit the ID 420, or to transmit the ID 420 upon receipt of a trigger signal from the receiver 320.

The RFID receiver 320 includes a receiving device 460 that receives the radio-frequency transmission from the transmitter 310 and a decoder 470 that extracts the ID from this received signal. The received ID is communicated to a processing device 330. The degree of processing by the processing device 330 is dependent upon the scheme used to convey the location identifying information via the ID 420. If the ID 420 is an explicit location identifier, such as an ASCII encoding of an address, the processing device 330 can merely be a display device. Alternatively, the ID 420 may be a unique identifier that is used to index explicit location identification information in a database 350. That is, for example, the database 350 may contain an identification of all locales within a geographic region, and the ID 420 is configured to identify the entry in the database 350 corresponding to the locale at which the ID 420 is located. The processing device 330 in such an embodiment includes a mapper 480 that is configured to provide the appropriate entry in the database 350 for display on a display device 490, based on the received ID from the transmitter 310 that is in the vicinity of the receiver 320.

This invention provides a number of commercial opportunities for facilitating the identification of locales. If the system 300 uses the optional database 350, a commercial opportunity exists for providing the entries to the database 350 and/or for providing updates or ancillary information for existing entries in the database 350. For example, if the entries in the database 350 include the address of each locale, the ancillary information could include the name of the owner of the property at the locale, the name of the current resident of the property, contact information regarding a sale of the property, and so on. If the locale is a commercial establishment, the ancillary information could include an advertisement, a reference to a web-site, an online catalog, and so on. In a preferred embodiment, the database 350, as well as the ancillary information, is downloadable from a web-site, so that the information can be easily updated or corrected. Optionally, the processing system 330 may be configured to provide wireless Internet access, for direct connection to a database 350 and ancillary information that is contained at an Internet-accessible web-site.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the processing system that is detailed above for the RFID embodiment can be utilized in a bar-code embodiment as well. Additionally, although this invention is presented using the examples of a bar-code embodiment and an RFID embodiment, other embodiments for sensing an identifier at a locale may also be used, including, for example a magnetic strip reader, an infrared transmitter/receiver, and so on. In like manner, the particular partitioning of functions among devices may differ from the example embodiments of FIGS. 2-4. For example, the resonance power source 410 arid transmitter 430 in the RFID transmitter 310 may be a single RF resonant circuit that receives the excitation signal, enters oscillation, and continues in oscillation, thereby entering a transmit mode, when the excitation signal is terminated. In like manner, the display 490 may be incorporated directly into the receiver 320, so that the combination of components 320 and 330 may be incorporated into a simple hand-held device that reads and displays location-identifying information. These and other system configuration and optimization features will be evident to one of ordinary skill in the art in view of this disclosure, and are included within the scope of the following claims.

I claim:

1. A locale identification system comprising:
a decoder that is configured to determine an identification from an identifier that is affixed to a structure that is associated with a segment of real property,
a memory, operably coupled to the decoder, that is configured to provide location identification information corresponding to the segment of real property, based on the identification from the identifier, and
a rendering device, operably coupled to the memory, that is configured to convey the location identification information to a user.

2. The locale identification system of claim 1, further including:
a scanner that is configured to optically scan the identifier to provide the identification to the decoder.

3. The location identification system of claim 2, wherein
the identification device includes a bar code that corresponds to an encoding of the identification.

4. The location identification system of claim 1, further including:
a receiver that is configured to receive a transmitted signal from the identifier to provide the identification to the decoder.

5. The location identification system of claim 4, further including:
a transmitter that is configured to trigger the identifier to transmit the transmitted signal to the receiver

6. The location identification system of claim 4, wherein
the transmitter includes
a resonance exciter that is configured to provide power to the identifier.

7. The location identification system of claim 1, further including
a location determining device that provides a geographic location, and wherein
the memory is configured to provide the location identification information based also on the geographic location.

8. The location identification system of claim 1, further including
an Internet access device that is configured to access a database that provides the location identification information to the memory.

9. The location identification system of claim 1, wherein the location identification information includes at least one of:
a name,
an address,
a location,
product information,
a telephone number, or
an advertisement.

10. A method of providing a location identification service, comprising:
providing a database of location identification information, and
providing a program that facilitates rendering the location identification information, based on an identification of a locale that is provided by an identifier that is affixed to a structure that is associated with the locale.

11. The method of claim 10, wherein
the database of location identification information is located at an Internet site.

12. The method of claim 10, wherein the location identification information includes at least one of:
a name,
an address,
a telephone number,
a location,
product information, or
an advertisement.

13. The method of claim 10, wherein
the program is configured to receive the identifier from at least one of:
an optical scanner, and
a radio receiver.

14. A method of providing information associated with a locale, comprising:
receiving an identification from an identifier that is affixed to the locale,
retrieving the information from a memory, based on the identification, and
rendering the information.

15. The method of claim 14, wherein
the memory recieves the information from an Internet site.

16. The method of claim 14, wherein the information includes at least one of:
a name,
an address,
a telephone number,
a location,
product information, or
an advertisement.

17. The method of claim 14, wherein
receiving the identification is via at least one of:
an optical scanner, and
a radio receiver.

18. The method of claim 14, further including
prompting the identifier to transmit the identification.

19. The method of claim 14, further including
transmitting power to the identifier, to initiate transmission of the identification.

20. The method of claim 14, wherein
the identification is encoded as a bar code.
